(19) United States
(12) Patent Application Publication
(10) Pub. No.: US 2006/0044980 A1
(43) Pub. Date: Mar. 2, 2006

(54) Recording/reproduction device, recording /reproduction method, recording/reproduction system, program thereof, and recording medium

(76) Inventors: Toshiyuki Fukushima, Osaka (JP); Hiroshi Sugimoto, Osaka (JP); Shinji Sasaki, Osaka (JP)

Correspondence Address: RATNERPRESTIA, P O BOX 980, VALLEY FORGE, PA, 19482-0980, US

(21) Appl. No.: 10/531,817

(22) PCT Filed: Jun. 2, 2004
(86) PCT No.: PCT/JP04/08000

§ 371 Date: Apr. 19, 2005

(30) Foreign Application Priority Data
Jun. 3, 2003 (JP) 2003-158590

(51) Int. Cl. G11B 19/04; G11B 20/10

(52) U.S. Cl. 369/53.21; 369/47.12

(57) ABSTRACT

A recording and replaying apparatus includes a drive controller which is connected to an optical disk drive and a disk information storage buffer which stores use conditions for an optical disk. When use conditions corresponding to identification information of the optical disk are stored in the disk information storage buffer, the drive controller instructs the optical disk drive to execute first adjustment processing. Whereas when use conditions corresponding to the identification information of the optical disk are not stored in the disk information storage buffer, the drive controller instructs the optical disk drive to execute second adjustment processing.

### FIELD OF THE INVENTION

The present invention relates to a recording and replaying apparatus, a recording and replaying method, a recording and replaying system,.a program thereof and a recording medium for recording and replaying on an optical disk.

### BACKGROUND ART

These days, apparatuses of recording and replaying on an optical disk are available for sale. An example is an optical disk recorder 1000 which records AV data such as images and sounds on an optical disk as shown in FIG. 14. Functions of the optical disk recorder 1000 are broadly divided into one for control of inputting and outputting of AV data, one for encoding and decoding into digital data in the event that analog AV data are handled, one for processing AV data into a data format which is proper for a loaded optical disk, and one for recording and replaying on an optical disk. An optical disk drive 110 is used as an apparatus which handles the function for recording and replaying on an optical disk among these functions.

For appropriate recording and replaying of data on a loaded optical disk, the power of laser is adjusted in the optical disk drive 110 (as described in Japanese Patent Application Laid-Open Gazette No. H04-141827 for instance). That is, signals are recorded in evaluation tracks of an optical disk to be used while gradually changing laser light and whether thus recorded signals are good is judged, and when the signals are found good as a result of the judgment, the lowest power within a range that the judgment remains positive is determined, whereby the adjustment is realized.

However, as the capacities of optical disks have become larger and the recording density has become higher over the recent years, processing of calculating an optimal value of a record and replay processing condition (hereinafter referred to as “adjustment processing”) has become necessary not only for the adjustment described above of the power of laser but also on other various conditions related to recording and replaying (hereinafter referred to as “recording and replaying conditions”). This has led to a problem of the longer time of the adjustment processing as a whole and hence the longer time until it becomes possible to execute recording or replaying after loading of an optical disk in the optical disk drive 110(hereinafter referred to as “start-up time”).

In addition, as a demand for optical disks has increased recently, a number of optical disk manufacturers have joined in development and sale, whereby the market finds optical disks having different characteristics relevant to recording and replaying from each other between different optical disk manufacturers or even in the case of the same optical disk manufacturer. Meanwhile, as for an optical disk drive incorporated inside an optical disk recorder, there is ongoing pursuit to shorten the adjustment processing time and improve the success rate of the adjustment processing through optimization of algorithm for the adjustment processing or saving of general recording and replaying conditions in the optical disk drive 110 in advance, to thereby ensure that the adjustment processing for optical disks which have been sold so far before shipping of the optical disk recorder will be performed appropriately. However, since optical disks sold after shipping of the optical disk recorder are not compatible with the optical disk recorder, there is a problem that the adjustment processing takes time and the start-up time becomes longer or that the adjustment processing fails and it therefore becomes impossible to perform recording, replaying, etc.

An approach to solve these problems may be storing the result of the adjustment processing above in a memory of the optical disk drive 110.

However, adding a memory to the optical disk drive 110 for storage of the result of the adjustment processing above pushes up a cost of the optical disk drive 110.

Further, concerning an optical disk sold before shipping of the optical disk recorder 1000 as more and more different types of disks have become available for sale, general recording and replaying conditions to be saved in the optical disk drive 110 in advance demand a larger capacity. A memory attached to the optical disk drive 110 generally has a small storage capacity for the purpose of cost reduction, etc., and hence, there is a problem that it is difficult to save all general recording and replaying conditions regarding all optical disks available on the market in the optical disk drive 110.

### SUMMARY OF THE INVENTION

The present invention has been made in light of the problems above, and accordingly, an object of the present invention is to provide a recording and replaying apparatus, a recording and replaying method, a recording and replaying system, a program and a recording medium capable of shortening the start-up time without increasing the memory capacity of an optical disk drive.

The 1^{st} aspect of the present invention is a recording and replaying apparatus, comprising:

a drive controller which houses an optical disk holding identification information, which is connected to an optical disk drive which controls start-up of and recording and replaying on said optical disk, and which controls said optical disk drive; and

a disk information storage buffer which is connected to said drive controller and stores use conditions which correspond to the identification information of an optical disk,

wherein when use conditions which correspond to the identification information of an optical disk to be used are stored in said disk information storage buffer, said drive controller instructs said optical disk drive so that said optical disk drive executes first adjustment processing using said use conditions, and

when said use conditions which correspond to the identification information of said optical disk to be used are not stored in said disk information storage buffer, said drive controller instructs said optical disk drive so that said optical disk drive executes second adjustment processing without using said use conditions.

The 2^{nd} aspect of the present invention is the recording and replaying apparatus according to the 1^{st} aspect of the present invention, wherein use conditions obtained as a result of said first adjustment processing or said second adjustment processing are stored in said disk information storage buffer from said optical disk drive.

The 3^{rd} aspect of the present invention is the recording and replaying apparatus according to the 1^{st} aspect of the present invention, wherein said use conditions for said optical disk are information which is used at the time of recording in said optical disk or replaying from said optical disk, said adjustment processing is processing of identifying use conditions for said optical disk to perform optimal recording or replaying on said optical disk.

The 4^{th} aspect of the present invention is the recording and replaying apparatus according to the 3^{rd} aspect of the present invention, wherein said information which is used at the time of recording or replaying is information regarding at least one of the power of laser, the pulse width of said laser and a servo condition.

The 5^{th} aspect of the present invention is the recording and replaying apparatus according to the 2^{nd} aspect of the present invention, wherein the identification information of said optical disk includes at least one of an individual ID, a manufacturer name and a model number, and said first adjustment processing includes first partial adjustment processing and second partial adjustment processing,

when said ID of said optical disk is stored in said disk information storage buffer, said drive controller instructs said optical disk drive so that said optical disk drive executes said first partial adjustment processing using said use conditions for said optical disk which correspond to said ID,

when said ID of said optical disk is not stored in said disk information storage buffer and said manufacturer name and/or said model number of said optical disk is stored in said disk information storage buffer, said drive controller instructs said optical disk drive so that said optical disk drive executes said second partial adjustment processing using said use conditions for said optical disk which correspond to said manufacturer name and/or said model number, and

use conditions obtained as a result of said first partial adjustment processing or said second partial adjustment processing are stored in said disk information storage buffer from said optical disk drive.

The 6^{th} aspect of the present invention is the recording and replaying apparatus according to the 3^{rd} aspect of the present invention, wherein said drive controller is capable of accessing, through a telecommunication line, a disk information storage device which stores the identification information of said optical disk and use conditions which correspond to the identification information, and

when use conditions which correspond to the identification information of said optical disk to be used are not stored in said disk information storage buffer, said drive controller instructs said optical disk drive so that said optical disk drive acquires use conditions which correspond to the identification information from said disk information storage device through said telecommunication line and executes said first adjustment processing using said use conditions instead of executing said second adjustment processing.

The 7^{th} aspect of the present invention is the recording and replaying apparatus according to the 6^{th} aspect of the present invention, wherein said disk information storage device stores said use conditions for each optical disk type and/or each optical disk manufacturer, corresponding to at least one of a manufacturer name, a model type and software information related to said recording and replaying apparatus and hardware information and software information related to said optical disk drive.

The 8^{th} aspect of the present invention is the recording and replaying apparatus according to the 7^{th} aspect of the present invention, wherein said information stored in said disk information storage device can be updated through said telecommunication line.

The 9^{th} aspect of the present invention is the recording and replaying apparatus according to the 3^{rd} aspect of the present invention, wherein said first adjustment processing or said second adjustment processing includes optimization of processing of recording or replaying in accordance with the temperature of said optical disk to be used or an ambient temperature.

The 10^{th} aspect of the present invention is a recording and replaying method, comprising the steps of:

when use conditions which correspond to identification information of an optical disk to be used in an optical disk drive are stored in a disk information storage buffer of an optical disk recorder which is connected to said optical disk drive, instructing to execute first adjustment processing using said use conditions; and

when said use conditions which correspond to the identification information of said optical disk to be used are not stored in said disk information storage buffer, instructing to execute second adjustment processing without using said use conditions.

The 11^{th} aspect of the present invention is the recording and replaying method according to the 10^{th} aspect of the present invention, comprising the step of storing use conditions obtained as a result of said first adjustment processing or said second adjustment processing in said disk information storage buffer.

The 12^{th} aspect of the present invention is a program which makes a computer function as said drive controller of the recording and replaying apparatus according to the 1^{st} aspect of the present invention.

The 13^{th} aspect of the present invention is a recording medium which holds the program according to the 12^{th} aspect of the present invention and which can be processed by a computer.

The 14^{th} aspect of the present invention is a recording and replaying system, comprising:

an optical disk drive which houses an optical disk holding identification information and controls start-up of and recording and replaying on said optical disk;

a drive controller which controls said optical disk drive; and

a disk information storage buffer which is connected to said drive controller and stores use conditions which correspond to the identification information of an optical disk,

wherein when use conditions which correspond to the identification information of an optical disk to be used are stored in said disk information storage buffer, said drive controller instructs said optical disk drive so that said optical disk drive executes first adjustment processing using said use conditions, and

when said use conditions which correspond to the identification information of said optical disk to be used are not stored in said disk information storage buffer, said drive controller instructs said optical disk drive so that said optical disk drive executes second adjustment processing without using said use conditions.

The 15^{th} aspect of the present invention is the recording and replaying system according to the 14^{th} aspect of the present invention, wherein use conditions obtained as a result of said first adjustment processing or said second adjustment processing are stored in said disk information storage buffer from said optical disk drive.

The 16^{th} aspect of the present invention is the recording and replaying system according to the 14^{th} aspect of the present invention, further comprising a disk information storage device which can be accessed through a telecommunication line and which stores the identification information of an optical disk and use conditions which correspond to the identification information.

The present invention provides a recording and replaying apparatus, a recording and replaying method, a recording and replaying system, a program and a recording medium capable of shortening the start-up time without increasing the memory capacity of an optical disk drive.

### BRIEF DESCRIPTION OF THE DRAWINGS

FIG. 1 is a configuration diagram of a recording and replaying system comprising a recording and replaying apparatus according to a first embodiment of the present invention;

FIG. 2 is a configuration diagram of the recording and replaying apparatus according to the first embodiment of the present invention;

FIG. 3 is a data configuration diagram of a disk information list stored in a disk information storage buffer of the recording and replaying apparatus according to the first embodiment of the present invention;

FIG. 4 is a flow chart of an operation of the recording and replaying apparatus according to the first embodiment of the present invention;

FIG. 5 is a drawing which shows operations of the recording and replaying apparatus and an optical disk drive according to the first embodiment of the present invention;

FIG. 6 is a flow chart of an operation of an optical disk drive which is connected to the recording and replaying apparatus according to the first embodiment of the present invention;

FIG. 7 is a flow chart of the operation of the optical disk drive which is connected to the recording and replaying apparatus according to the first embodiment of the present invention;

FIG. 8 is a configuration diagram of a recording and replaying system comprising a recording and replaying apparatus according to a second embodiment of the present invention;

FIG. 9 is a configuration diagram of the recording and replaying apparatus according to the second embodiment of the present invention;

FIG. 10 is a configuration diagram of a server which is connected to the recording and replaying apparatus according to the second embodiment of the present invention;

FIG. 11 is a data configuration diagram of a disk product information list stored in a disk product information storage buffer of the server which is connected to the recording and replaying apparatus according to the second embodiment of the present invention;

FIG. 12 is a flow chart of an operation of the recording and replaying apparatus according to the second embodiment of the present invention;

FIG. 13 is a drawing which shows operations of the recording and replaying apparatus, an optical disk drive and a server according to the second embodiment of the present invention; and

FIG. 14 is a configuration diagram of a recording and replaying system comprising a conventional recording and replaying apparatus.

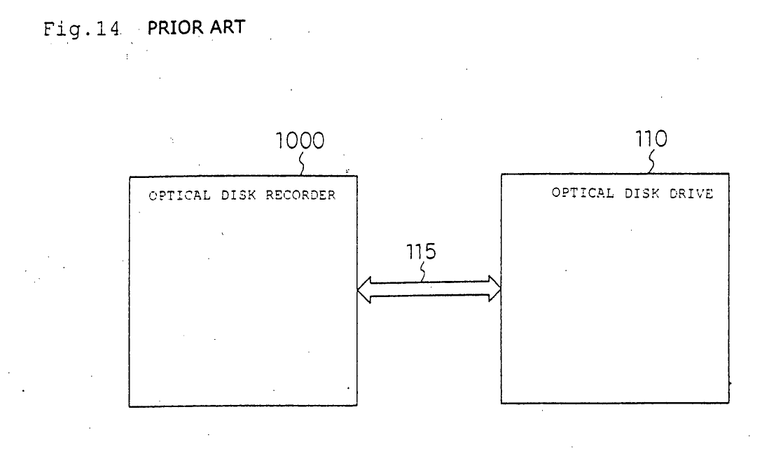

### EXPLANATION OF THE REFERENCE SYMBOLS

100 optical disk recorder
123 drive controller
102 disk information storage buffer
110 optical disk drive
111 start-up control part
112 recording and replaying condition storage buffer
113 recording and replaying condition adjuster
114 recording and replaying controller
120 optical disk
200 disk information list
210 header
220 disk information
221 disk identification information
222 recording and replaying conditions
600 optical disk recorder
603 network control part
630 server
631 disk product information storage buffer
633 network control part
640 network
700 disk product information list
710 header
760 disk product information
770 disk identification information
780 recording and replaying conditions

### BEST MODE FOR IMPLEMENTING THE INVENTION

Embodiments of the present invention will now be described with reference to the associated drawings.

### First Embodiment

A first embodiment provides a recording and replaying apparatus which shortens the adjustment time needed for various types of optical disks which can be loaded in the recording and replaying apparatus, and a method of adjusting a use condition.

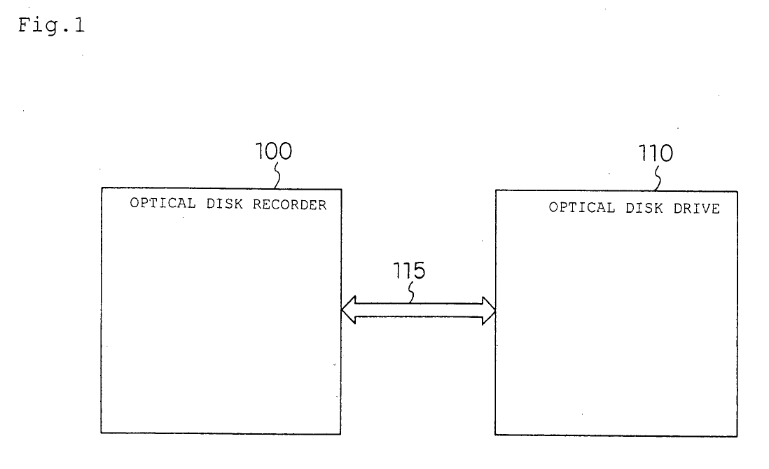

FIG. 1 shows the configuration of an optical disk recorder system which uses the recording and replaying apparatus according to the first embodiment of the present invention.

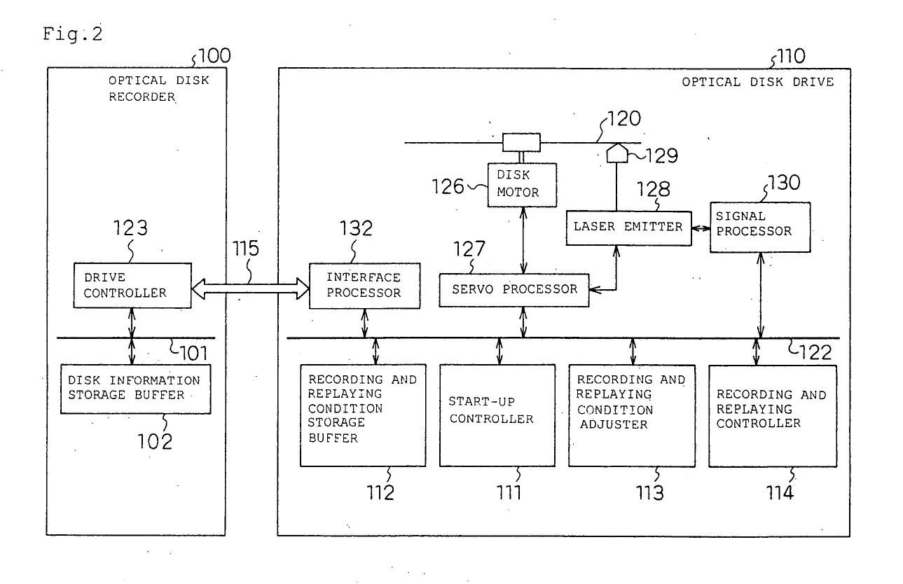

An optical disk recorder 100 which is one example of the recording and replaying apparatus according to the present invention is connected to an optical disk drive 110 through a serial bus 115. FIG. 2 shows the configurations of the optical disk recorder 100 and the optical disk drive 110. A disk information storage buffer 102 and a drive controller 123 which controls the optical disk drive 110 are connected to a bus 101 of the optical disk recorder 100. Stored in the disk information storage buffer 102 are recording and replaying conditions which relate to an optical disk 120 loaded in the optical disk drive 110 and are one example of use conditions according to the present invention. The serial bus 115 is connected to the drive controller 123.

Elements which form the optical disk recorder 100 include, in addition to those described above, various types of drivers, an encoder which encodes a picture signal and an audio signal, a decoder which decodes an encoded signal, a solid-state memory such as an HDD, a panel operation part, a buffer memory, an input part, an output control part, a display part, etc., which will not be described here.

Connected to a bus 122 of the optical disk drive 110 are a start-up controller 111 which controls start-up processing for the loaded optical disk 120, a recording and replaying condition adjuster 113 which controls adjustment processing, a recording and replaying condition storage buffer 112 which stores the result of the adjustment processing, a recording and replaying controller 114 which controls recording on the optical disk 120 and replaying from the optical disk 120, a servo processor 127, a signal processor 130 and an interface processor 132. A laser emitter 128 is connected to the servo processor 127, while an optical pickup 129 is connected to the laser emitter 128. The laser emitter 128 and the signal processor 130 are connected to each other. A disk motor 126 which rotates the optical disk 120 is connected to the servo processor 127. The serial bus 115 is connected to the interface processor 132.

The disk information storage buffer 102 of the optical disk recorder 100 is a recording medium which stores recording and replaying conditions, etc. The disk information storage buffer 102 is a semiconductor memory, a hard disk, or the like for instance.

The types of the optical disk 120 loaded in the optical disk drive 110 are Blu-ray Disk, DVD-RAM, DVD−R, DVD-ROM, DVD−RW, DVD+R, DVD+RW, etc.

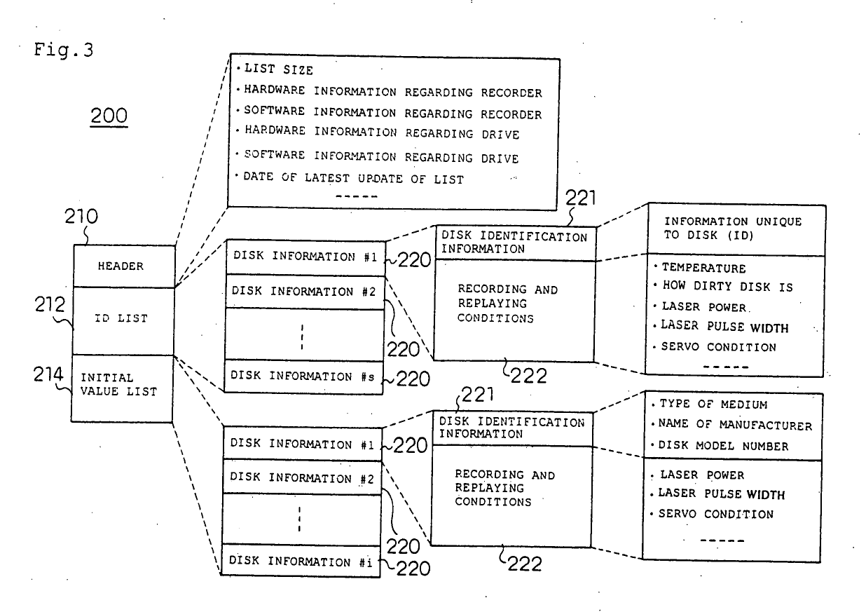

FIG. 3 shows one example of the configuration of a disk information list 200 stored in the disk information storage buffer 102.

The disk information list 200 contains a header 210 indicative of the entire size of the optical disk 120 and the like, an ID list 212 and an initial value list 214. The ID list 212 and the initial value list 214 are comprised of one or more pieces of disk information 220 storing information regarding the optical disk 120. The symbols #s and #i are used merely for convenience, while the letters s and i denote integers of 1 or more.

Contained in the header 210 is at least one of the list size, hardware information and software information regarding the optical disk recorder 100, hardware information and software information regarding the optical disk drive 110, the last update date of the list, and the like.

The disk information 220 includes disk identification information 221 from which the optical disk 120 loaded in the optical disk drive 110 is identified, and recording and replaying conditions 222 related to the loaded optical disk 120.

An ID of each optical disk 120, which is unique to the optical disk 120 and is able to identify the optical disk 120, including the type, the name of the manufacturer, the model number, the disk ID or the like of the optical disk 120 is described in the disk identification information 221 of the ID list 212, whereas recording and replaying conditions for the optical disk 120 corresponding to the ID of the optical disk 120 are described in the recording and replaying conditions 222. In short, the recording and replaying conditions which are described correspond to the ID of the optical disk 120 which was once used in the optical disk recorder 100, the temperature at which the optical disk 120 was used and how dirty the optical disk 120 is. Such recording and replaying conditions may be a laser power, a laser pulse width, a servo condition, etc.

The disk identification information 221 of the initial value list 214 describes at least one of the type of the optical disk (medium) 120, the name of the manufacturer of the optical disk, and the model number of the disk, while the recording and replaying conditions 222 describe recording and replaying conditions for the optical disk 120 which correspond to these. In other words, recording and replaying conditions in an initial state of the optical disk 120 similar to the above are described.

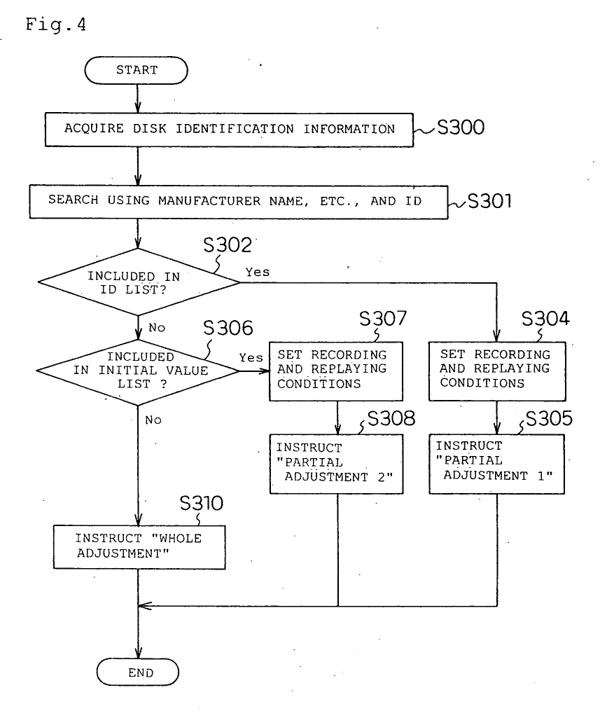

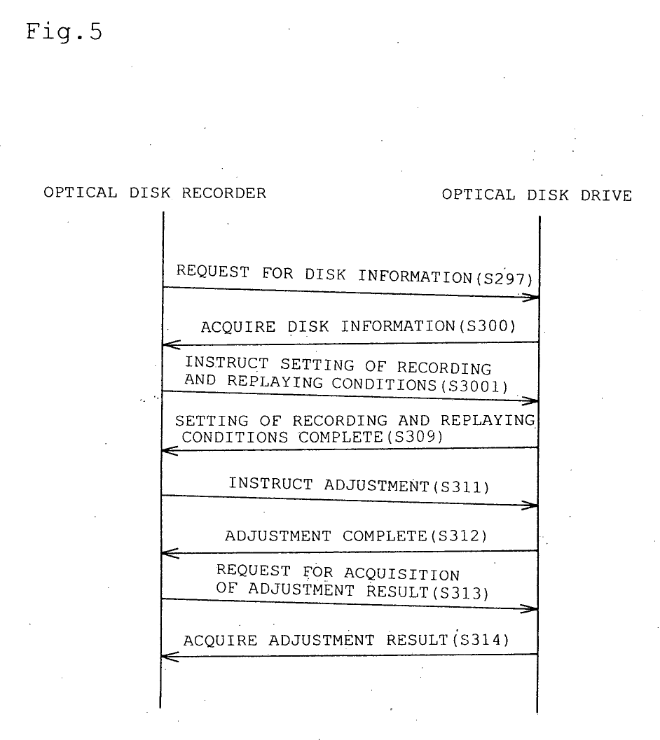

FIG. 4 is a flow chart which shows the flow of the start-up processing which is executed on the optical disk drive 110 by the optical disk recorder 100 at the time of loading of the optical disk 120. FIG. 5 shows how information is transferred between the optical disk recorder 100 and the optical disk drive 110 at that stage. Operations of the optical disk recorder 100 and the optical disk drive 110 will now be described with reference to FIGS. 4 and 5.

The drive controller 123 requests the optical disk drive 110 for disk information (Step 297), and after detection of loading of the optical disk 120 in the optical disk drive 110, the drive controller 123 acquires disk identification information regarding the loaded optical disk 120 from the optical disk drive 110 (Step 300).

Based on thus acquired disk identification information, the drive controller 123 searches the disk information list 200 (Step 301). When it is found as a result that the ID contained in the acquired disk identification information (information unique to the disk) is present within the ID list 212 (i.e., Yes at Step 302), the drive controller 123 transmits the recording and replaying conditions 222 described in the ID list 212 to the optical disk drive 110, and the optical disk drive 110 sets thus received recording and replaying conditions 222 in the recording and replaying condition storage buffer 112 (Step 304, Step 3001). As the setting of the conditions in the optical disk drive 110 completes (Step 309), the drive controller 123 instructs the recording and replaying condition adjuster 113 of the optical disk drive 110 and so that the optical disk drive 110 will perform adjustment processing (which will be hereinafter referred to as “partial adjustment 1” which is one example of first partial adjustment processing according to the present invention) using thus set received recording and replaying conditions 222 as reference parameters (Step 305). Instructed by the optical disk drive 110, the recording and replaying adjuster 113 executes the partial adjustment 1.

The state that the disk identification information is present within the ID list 212 is a state that the disk identification information of the optical disk 120 which was used before is added to the ID list 212 together with the recording and replaying conditions which were used at that time.

During the partial adjustment 1, as for the optical disk 120 to be used, the recording and replaying conditions (e.g., the temperature, the degree of dirtiness, etc.) for the optical disk 120 which was used previously are known from the beginning, and hence, at Step 305, the drive controller 123 transmits to the optical disk drive 110 only those conditions among the recording and replaying conditions for the optical disk 120 to be used which could change from as they were during the previous use so that those conditions will be optimized, and the optical disk drive 110 instructs the recording and replaying condition adjuster 113 as for thus transmitted recording and replaying conditions.

In the absence of the ID corresponding to the acquired disk identification information is not present in the ID list 212 (No at Step 302), when the name of the manufacturer, the model number or the like corresponding to the acquired disk identification information is present within the initial value list 214 (Yes at Step 306), the drive controller 123 transmits the recording and replaying conditions 222 described in the initial value list 214 to the optical disk drive 110, and the optical disk drive 110 sets thus transmitted recording and replaying conditions 222 in the recording and replaying condition storage buffer 112 (Step 307, Step 3001). As the setting of the conditions in the optical disk drive 110 completes (Step 309), the drive controller 123 instructs the recording and replaying condition adjuster 113 via the optical disk drive 110 so that the recording and replaying condition adjuster 113 will perform adjustment processing (which will be hereinafter referred to as “partial adjustment 2” which is one example of second partial adjustment processing according to the present invention) using thus set transmitted recording and replaying conditions 222 as reference parameters (Step 308, Step 311).

The state that the disk identification information is present within the initial value list 214 is equal to the state that the disk identification information 221 and the recording and replaying conditions 222 matching with the name of the manufacturer, the model number or the like of the optical disk 120 to be used are present within the initial value list 214.

Meanwhile, the recording and replaying conditions are operating conditions for the optical disk drive 110 under which the optical disk drive 110 records information in the optical disk 120 or replays information recorded in the optical disk 120. The recording and replaying conditions include at least one of a pulse condition regarding laser irradiated upon the optical disk 120, a servo condition which determines operations of various types of servo during recording and replaying, and a replay signal processing condition for processing a replay signal. Further, the pulse condition includes the power value of the laser which is irradiated upon the optical disk during recording. Alternatively, the pulse condition may include a condition regarding the laser for forming a mark (which is the minimum unit of information) on the optical disk. FIG. 3 shows parameters related to the power of the laser, the pulse width of the laser, servo control and the like for recording and replaying, but the parameters are not limited to them.

In addition, during the partial adjustment 2, such adjustment processing is executed to attain optimization for the optical disk 120 to be used, utilizing the recording and replaying conditions for the optical disk 120 obtained from the initial value list 214. Hence, at Step 308, the drive controller 123 instructs the optical disk drive 110 to perform such adjustment processing.

On the contrary, when the disk information 220 which corresponds to the acquired disk identification information is not present (No at Step 306), the drive controller 123 instructs the optical disk drive 110 to perform adjustment processing on the premise that no parameter suitable to this optical disk 120 is available (hereinafter referred to as “whole adjustment”) (Step 311). During the whole adjustment, all recording and replaying conditions for the optical disk 120 are optimized.

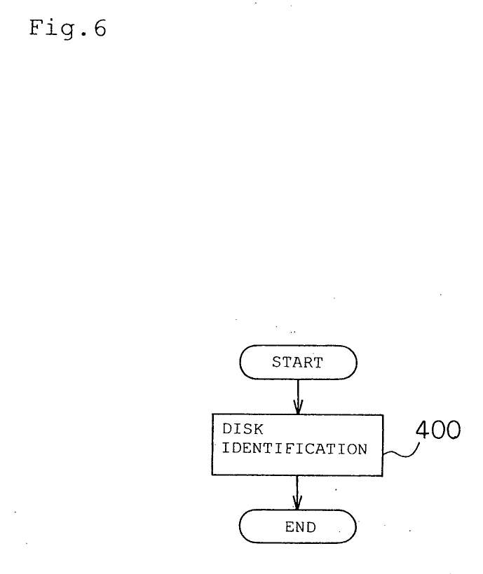

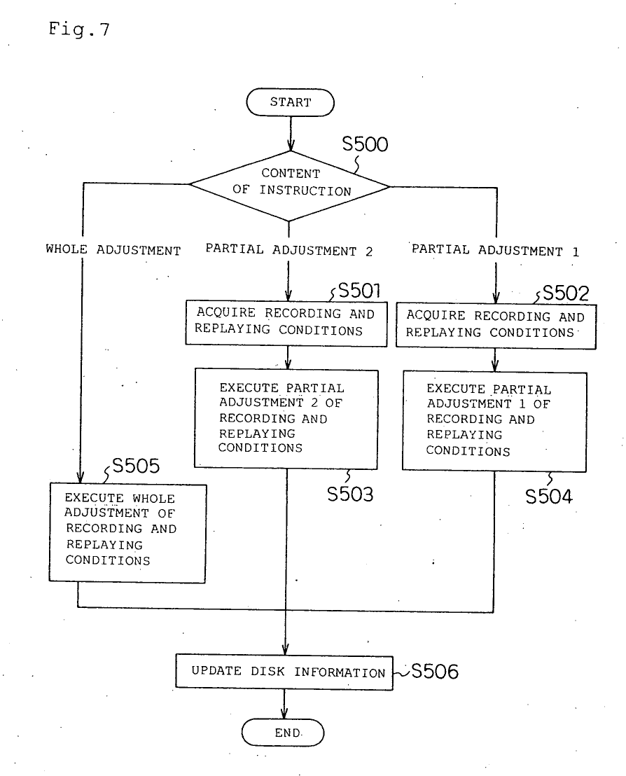

FIGS. 6 and 7 are flow charts which show the flow of operations which the optical disk drive 110 performs as instructed by the optical disk recorder 100 when the optical disk 120 is loaded in the optical disk drive 110.

FIG. 6 will be referred to first.

When the optical disk drive 110 receives an instruction from the optical disk recorder 100 for acquisition of the disk identification information (Step 297), the start-up control part 111 identifies the optical disk 120 (Step 400) and sends thus acquired disk identification information to the optical disk recorder 100 (Step 300).

FIG. 7 will now be described.

Instructed by the optical disk recorder 100 to perform adjustment processing (FIG. 5, Step 311), the optical disk drive 110 stores the content of the instruction in the recording and replaying condition storage buffer 112. The recording and replaying condition adjuster 113 of the optical disk drive 110 then analyzes the content of the received instruction (Step 500) When the content of the instruction is adjustment processing using the recording and replaying conditions 222 stored in the recording and replaying condition storage buffer 112 as reference parameters (“partial adjustment 1” or “partial adjustment 2” at Step 500), the recording and replaying condition adjuster 113 acquires the recording and replaying conditions 222 stored in the recording and replaying condition storage buffer 112 (Step 501 or Step 502), and performs adjustment processing using the recording and replaying conditions 222 as reference parameters (Step 503 or Step 504). On the other hand, when the content of the instruction is execution of adjustment processing on the premise that no reference parameter suitable to this optical disk 120 is available (“whole adjustment” at Step 500), the recording and replaying condition adjuster 113 performs adjustment processing without using reference parameters or using reference parameters saved in the recording and replaying condition storage buffer 112 for general purposes for instance(Step 505).

In this case, although when it is possible to use general recording and replaying conditions saved in the optical disk drive 110 for the loaded optical disk 120, adjustment processing is executed based on these recording and replaying conditions, in the case of the optical disk 120 which does not allow use of general recording and replaying conditions or upon failure of adjustment processing based on general recording and replaying conditions, adjustment processing is repeated until optimal recording and replaying conditions have been found.

As the instruction calling for the adjustment is completed (FIG. 5, Step 312), the drive controller 123 of the optical disk recorder 100 requests the optical disk drive 110 to acquire the result of the adjustment (FIG. 5, Step 313). Receiving the result of the adjustment from the optical disk drive 110 (FIG. 5, Step 314), the drive controller 123 updates the disk information (Step 506). That is, regardless of whether the adjustment processing is the whole adjustment, the partial adjustment 1 or the partial adjustment 2, the drive controller 123 acquires the recording and replaying conditions optimized as a result of the adjustment processing from the optical disk drive 110 (FIG. 5, Step 314) and adds these to the ID list 212 together with the disk identification information.

As the disk information list 200 is searched based on the disk identification information and the corresponding recording and replaying conditions 222 are utilized for the adjustment processing in this manner, the time needed for the adjustment processing is shortened, which makes the adjustment processing more likely succeed. This makes it possible to shorten the start-up time.

Particularly when recording or replaying is resumed without ejection of the optical disk 120 after the standby state (e.g., suspend), the recording and replaying conditions obtained as a result of the adjustment processing are acquired immediately from the disk information list 200 of the disk information storage buffer 102 and utilized, and no time is needed before the recording and replaying processing. Further, while supply of power to the optical disk drive 110 is suspended in general to save electric power when the optical disk drive 110 is in the standby state, supply of electric power to the disk information storage buffer 102 is not stopped unless supply of power to the optical disk recorder 100 itself is stopped, and the stored recording and replaying conditions are maintained even in the standby state. In consequence, even though the recording and replaying conditions are not stored in the recording and replaying condition storage buffer 112 of the optical disk drive 110 when the optical disk drive 110 changes from the standby state to the ready-for-recording/replaying state without ejection of the optical disk 120, the recording and replaying controller 114 can immediately use those recording and replaying conditions which are necessary for resumption of recording or replaying.

In addition, with the recording and replaying conditions 222 stored in the disk information storage buffer 102 of the optical disk recorder 100, it is possible to store the recording and replaying conditions 222 which are related to many optical disks 120, and therefore, it is possible to shorten the adjustment processing time and enhance the possibility that the adjustment processing will succeed. Further, since it is not necessary to store the recording and replaying conditions related to many optical disks 120 in the recording and replaying condition storage buffer 112 of the optical disk drive 110, the memory capacity can be suppressed. In other words, a general-purpose product such as a personal computer may be used as the optical disk drive 110.

Although the result of any one of the whole adjustment, the partial adjustment 1 and the partial adjustment 2 is stored in the disk information storage buffer 102 in this embodiment, the result of the whole adjustment or the partial adjustment 2 may be stored in the disk information storage buffer 102.

What is stored in the disk identification information is not limited to the ID, the name of the manufacturer and the model number, but may be other information such as a serial number. The lists may be other lists than the initial value list 214 and the ID list 212. Even in such a case, the partial adjustment using corresponding recording and replaying conditions shortens the start-up time after interruption of recording or replaying.

### Second Embodiment

A second embodiment provides a recording and replaying apparatus which shortens the adjustment time needed for optical disks 120 sold after shipment of an optical disk recorder, and a method of adjusting a recording and replaying condition.

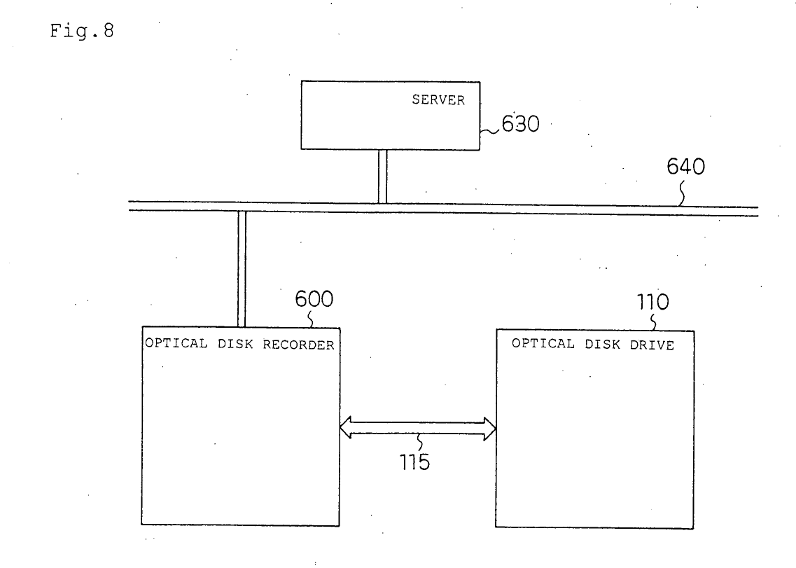

FIG. 8 shows the configuration of a recording and replaying system which uses the recording and replaying apparatus according to the second embodiment of the present invention.

An optical disk recorder 600 is connected with a server 630 which is one example of a disk information storage device according to the present invention via a network 640 which is one example of a telecommunication line according to the present invention. Such a network 640 includes, but not limited to, the Internet. Further, the optical disk recorder 600 is connected to an optical disk drive 110 through a serial bus 115.

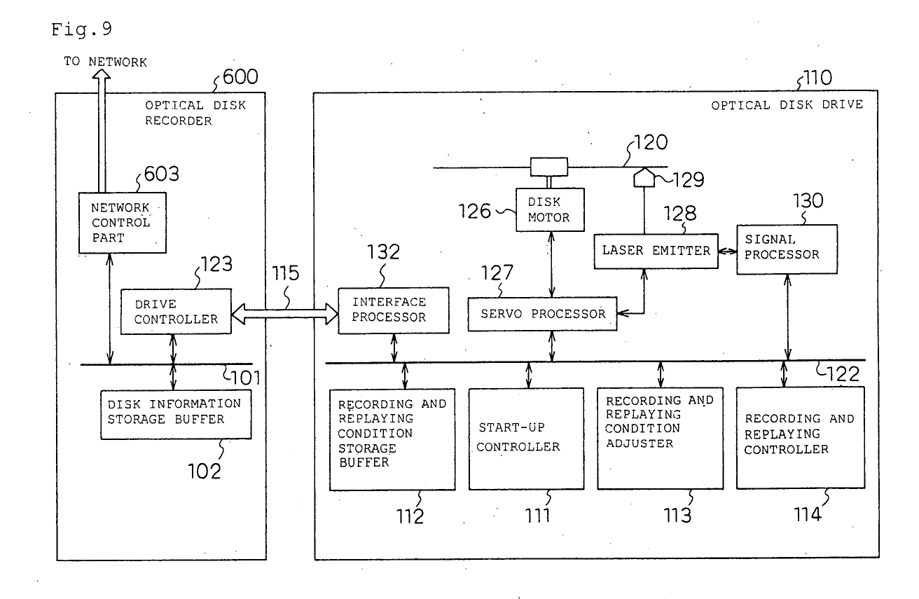

FIG. 9 shows the configurations of the optical disk recorder 600 and the optical disk drive 110. A network control part 603 of the optical disk recorder 600 controls telecommunication processing which is conducted through the network 640. Other elements which form the optical disk recorder 600 are the same as those according to the first embodiment, and therefore, will not be described. In addition, since the configuration of the optical disk drive 110 is the same as that according to the first embodiment, and therefore, will not be described.

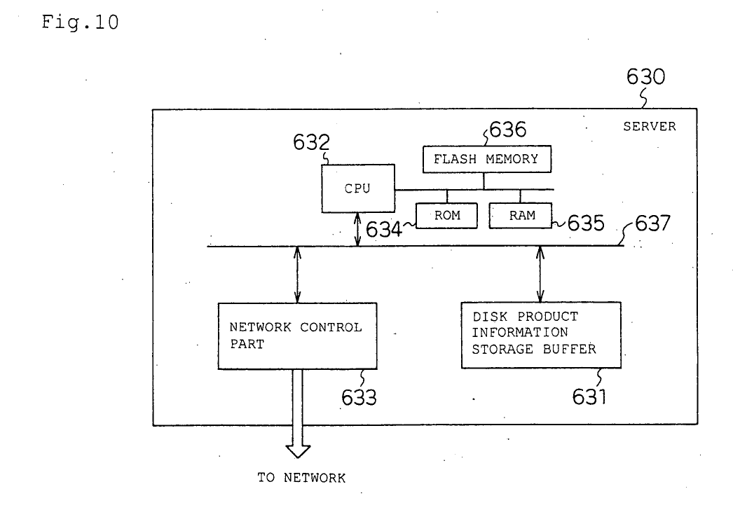

FIG. 10 shows the configuration of the server 630. The server 630 comprises a network control part 633 which controls telecommunication processing which is conducted through the network 640, a disk product information storage buffer 631 which stores recording and replaying conditions regarding optical disks sold in the market, a CPU 632, a ROM 634, a RAM 635 and a flash memory 636 which control inputting of information to the disk product information storage buffer 631 and outputting of information from the disk product information storage buffer 631, and a bus 637.

The disk product information storage buffer 631 is a recording medium. For instance, a semiconductor memory, a hard disk or the like may be used.

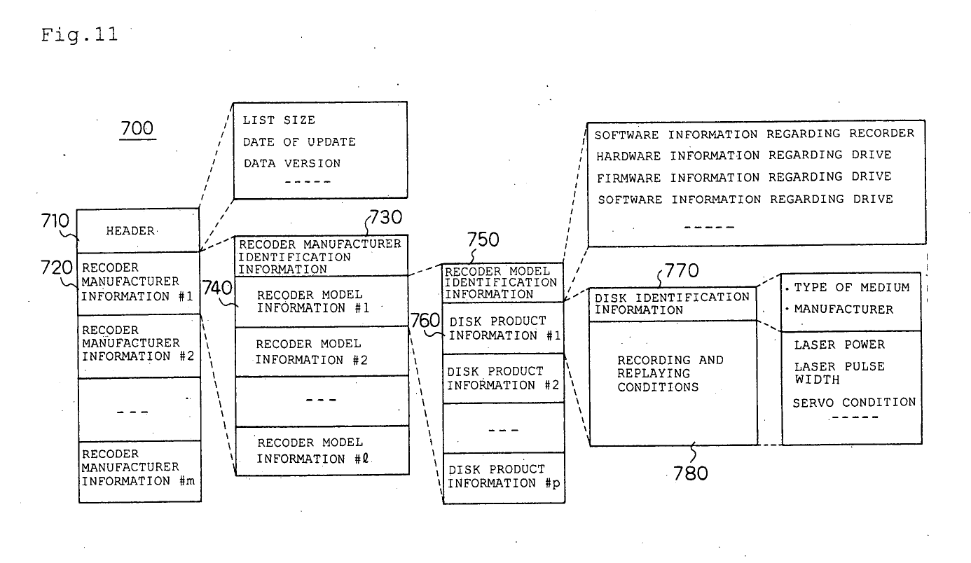

FIG. 11 shows an example of the configuration of a disk product information list 700 which is stored in the disk product information storage buffer 631.

The disk product information list 700 contains a header 710 which includes at least one of the whole size, the date of update, the data version and the like, and one or more pieces of recorder manufacturer information 720 storing information regarding optical disk recorders 600 sold in the market. Each recorder manufacturer information 720 includes recorder manufacturer identification information 730 and one or more pieces of recorder model information 740 storing information regarding the model type of the optical disk recorders 600 of the corresponding manufacturer. Each recorder model information 740 includes recorder model identification information 750 and one or more pieces of disk product information 760 storing information regarding optical disk products 120 sold in the market. The recorder model identification information 750 includes at least one of software information regarding the recorder, hardware information regarding the drive, firmware information regarding the drive and software information regarding the drive. Each disk product information 760 includes disk identification information 770 storing at least one of the type of the optical disk (recording medium) 120, the name of the manufacturer and the like, and recording and replaying conditions 780 corresponding to each type of optical disks 120 and/or the name of each manufacturer. The symbols #m, #l and #p are used merely for convenience, while the letters m, l and p denote integers of l or more.

The disk product information 760 is updated in response to an external operation via the network 640 or a direct operation from the server 630 every time a new type of optical disks 120 become available in the market.

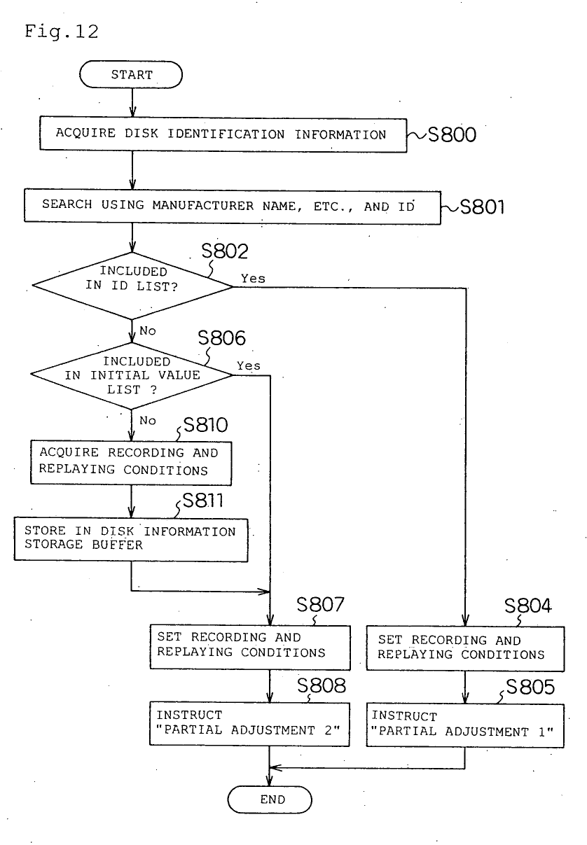

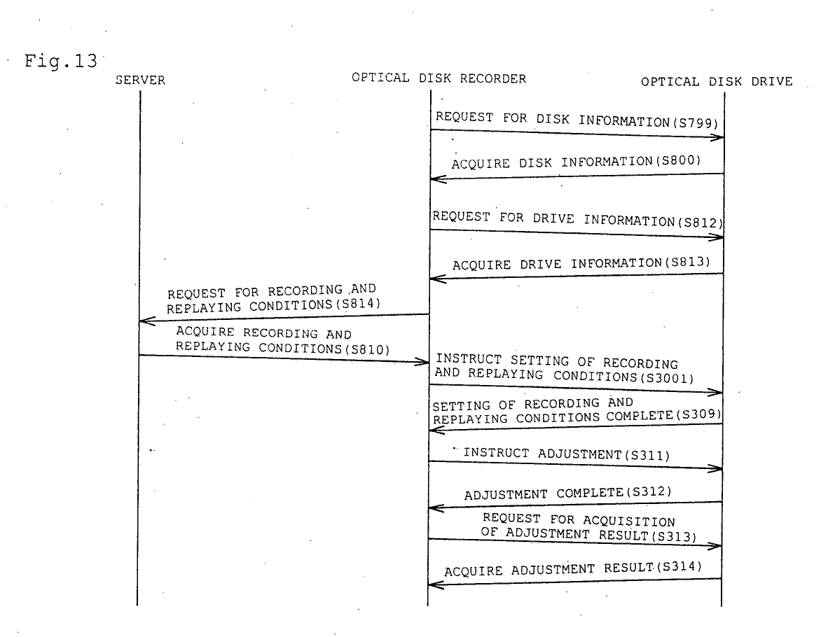

FIG. 12 is a flow chart which shows the flow of the start-up processing which is executed on the optical disk drive 110 by the optical disk recorder 600 at the time of loading of the optical disk 120 according to the second embodiment. FIG. 13 shows how information is transferred between the optical disk recorder 600, the optical disk drive 110 and the server 630 at that stage. Operations of the optical disk recorder 600 and the optical disk drive 110 will now be described with reference to FIGS. 12 and 13.

After detecting loading of the optical disk 120 in the optical disk drive 110, the drive controller 123 acquires disk identification information regarding the loaded optical disk 120 from the optical disk drive 110 (Step 799, Step 800). Step 801, Step 802, Step 804, Step 805, Step 806, Step 807 and Step 808 correspond respectively to Step 301, Step 302, Step 304, Step 305, Step 306, Step 307 and Step 308 which are shown in FIG. 4, and therefore, will not be described.

At Step 806, in the event that the acquired disk identification information does not correspond to the initial value list 214, the drive controller 123 first requests the optical disk drive 110 for the name of the manufacturer of the optical disk drive 110, the model type, software information and the like (hereinafter referred to as “drive information”) (Step 812). Sending the disk identification information acquired at Step 800, the recorder manufacturer identification information, the recorder model identification information and the like regarding the optical disk recorder 100 (hereinafter referred to as “recorder manufacturer information”) and the drive information (which is at least one of drive hardware information, drive firmware information and drive software information) regarding the optical disk drive 110 acquired from the optical disk drive 110 (Step 813) to the server 630 through the network control part 603, the drive controller 123 requests for recording and replaying conditions 780 (Step 814). Receiving the request, the server 630 searches the disk product information list 700 which is stored in the disk product information storage buffer 631, and sends recording and replaying conditions 780 which correspond to the recorder manufacturer information, the drive information and the disk identification information thus received to the optical disk recorder 600 through the network control part 633. Receiving thus sent recording and replaying conditions 780, the optical disk recorder 600 acquires recording and replaying conditions 780 (Step 810). Following this, the drive controller 123 updates the initial value list 214 using the recording and replaying conditions 780 and the disk identification information thus acquired, stores them in the disk information storage buffer 102 (Step 811), and sets the recording and replaying conditions 780 in the optical disk drive 110 (Step 807, Step 3001 in FIG. 13, and Step 309). At last, the drive controller 123 instructs execution of the adjustment processing using thus set recording and replaying conditions 780 as reference parameters (Step 808 and Step 311 in FIG. 13). Subsequent processing (Step 312, Step 313, and Step 314) is the same as that shown in FIG. 5, and therefore, will not be described.

Since the flow of the operation which the optical disk drive 110 conducts in response to the instruction from the optical disk recorder 600 is similar to that according to the first embodiment except for the absence of the whole adjustment, and therefore, will not be described.

As described above, when an unknown optical disk 120 sold after shipment of the optical disk recorder 600 is loaded in the optical disk drive 110, corresponding recording and replaying conditions 780 are acquired from the server 630 connected to the network 640 and are utilized for the adjustment processing, thereby shortening the adjustment processing time needed even for the unknown optical disk 120 and enhancing the possibility that the adjustment processing will succeed. This makes it possible to shorten the start-up time. In other words, while the recording and replaying apparatus according to the first embodiment must execute the whole adjustment when the optical disk 120 is unknown, the whole adjustment is not necessary in the case of the recording and replaying apparatus according to this embodiment, thereby further shortening the start-up time.

The recording and replaying conditions are parameters regarding the power of laser for recording and replaying, a laser pulse width, a servo condition, etc., which is not limiting. For example, a program for the adjustment processing and the like may be included, in addition to these parameters.

While the foregoing has described that when recording and replaying conditions which correspond to disk identification information are not present in the disk information list 200, the disk information list 200 is updated based on recording and replaying conditions 780 acquired from the server 630, this is not limiting. For instance, after the adjustment processing is completed, optimized recording and replaying conditions may be acquired from the optical disk drive 110 and the disk information list 200 may be updated based on these recording and replaying conditions.

Further, the disk identification information 770 may include a serial number such as the product number, the production number or the like of the optical disk 120.

Further, the network may be IEEE 1394, USB, etc., besides the Ethernet (registered trademark).

With such a server established on the network, it is possible to provide the purchaser of the optical disk recorder a service which improves the function and the capability after the purchase.

Further, although the foregoing has described that recording and replaying conditions are acquired via the network, this is not limiting. For instance, recording and replaying conditions may be acquired via broadcasting such as digital broadcasting.

Further, while disk product information is stored in the server according to the second embodiment, this is not limiting. For example, disk product information may be stored in an SD card and recording and replaying conditions may be acquired with the SD card connected to the optical disk recorder, or alternatively, disk product information may be stored in an optical disk such as a DVD-ROM and recording and replaying conditions may be acquired when this disk is loaded.

Further, although the foregoing has described that the server connected to the network are asked for recording and replaying conditions 780 according to the second embodiment, this is not limiting. For example, the optical disk recorders may be connected to each other via the network and the counterpart optical disk recorder may be asked for recording and replaying conditions which correspond to a loaded optical disk. In this case, the disk information storage device according to the present invention corresponds to other recording and replaying apparatus.

Further, the network control part 603 may not be present. In other words, an effect similar to the above is obtained as long as the drive controller according to the present invention can access the disk information storage device according to the present invention via a telecommunication line.

In the foregoing, the first adjustment processing according to the present invention corresponds to Step 305 or Step 308 in the example shown in FIG. 4, Step 503 or Step 504 in the example shown in FIG. 7, and Step 808 or Step 805 in the example shown in FIG. 12, whereas the second adjustment processing according to the present invention corresponds to Step 310 in the example shown in FIG. 4 or Step 505 in the example shown in FIG. 7.

Further, although the foregoing has described that recording and replaying conditions for the optical disk 120 are optimized during the partial adjustment 1 and the partial adjustment 2 as well, as for a parameter such as the laser pulse width which does not easily change in terms of characteristic in response to temperature, the recording and replaying condition as it is set is used without re-adjustment when the instruction calls for “the partial adjustment 1” or “the partial adjustment 2” to thereby shorten the adjustment processing time.

Further, in the foregoing, when the recording and replaying conditions 222 stored in the disk information list 200 include a parameter such as the laser power which changes in terms of characteristic in response to a temperature change, for the purpose of making it possible to set an optimal recording and replaying condition in accordance with the temperature at which the optical disk 120 is loaded, the recording and replaying conditions 222 to be stored in the disk information list 200 may be held as a list which contains the recording and replaying conditions 222 for every 10° C. from 0° C. to 60° C. for instance. In this case, the drive controller 123 may acquire the temperature of the optical disk drive 110 when acquiring disk identification information and the corresponding recording and replaying condition may be set. Alternatively, the recording and replaying conditions 222 for all temperatures which correspond to disk identification information may be set in the recording and replaying condition storage buffer 112 of the optical disk drive 110, and appropriate recording and replaying conditions may be used in accordance with the temperature of the optical disk 120 or the optical disk drive 110 while the recording and replaying condition adjuster 113 performs the adjustment processing.

Further, although the foregoing has described that the recording and replaying apparatus according to the present invention is the optical disk recorder 100 or 600, this is not limiting. The recording and replaying apparatus may however be any apparatus which records and replays on the optical disk 120.

Further, although the foregoing has described the optical disk recorder 100 or 600 and the optical disk drive 110 as separate structures, these may be disposed in one housing for instance.

Further, although the foregoing has described that recording and replaying conditions which correspond to the disk identification information regarding the loaded optical disk 120 are present within the disk information list 200 or the disk product information list 700, the adjustment processing is performed using these recording and replaying conditions, this is not limiting. For instance, recording and replaying may be performed using these recording and replaying conditions while substantially skipping the adjustment processing. This means that the first adjustment processing according to the present invention in this case is substantially no adjustment processing.

Further, although the foregoing has described the processing of optimizing recording and replaying conditions in accordance with the state of the optical disk 120 to be used, this is not limiting. For instance, considering a possibility that the characteristics will change owing to dust on the optical pickup 129 of the optical disk drive 110, recording and replaying conditions may be acquired every time the adjustment processing completes and the disk information list 200 may be updated. An effect similar to the above is obtained even in such a case.

Further, acquired disk identification information may be stored in a different buffer from the disk information storage buffer, thereby allowing use of the disk identification information stored in the buffer without acquisition of the disk identification information from the optical disk drive 110 when the start-up processing is to be executed with the optical disk 120 loaded.

Further, although the foregoing has described that the optical disk drive 110 determines whether to use recording and replaying conditions in accordance with an instruction from the optical disk recorder 100 when the adjustment processing is to be executed, this is not limiting. For instance, the optical disk drive 110 may determine whether recording and replaying conditions have been set in the optical disk drive 110 and use the recording and replaying conditions for the adjustment processing when determining the recording and replaying conditions have been set.

Further, in the foregoing, the information stored in the disk identification information 221 and the disk identification information 770 includes not only information regarding the optical disk 120 but also information regarding the optical disk drive 110 incorporated inside the optical disk recorder 600, e.g., information available from the manufacturer, information regarding the product, a serial number, etc. This makes it possible to absorb a difference in recording and replaying conditions attributable to an individual difference of the optical disk drive 110.

A recording and replaying system which comprises the optical disk recorder 100 or 600 and the optical disk drive 110 is also within the scope of the present invention.

Further, although the foregoing has described the optical disk drive according to the present invention in light of a general-purpose product such as an optical disk drive of a personal computer, this is not limiting.

In addition, the present invention is directed to a program which operates in co-operation with a computer and which makes the computer execute the functions of all or some means of the drive controller described above according to the present invention.

Moreover, the present invention is directed to a recording medium which can be read on a computer and stores a program for the drive controller described above according to the present invention, which operates in co-operation with a computer and which makes the computer execute the functions mentioned above.

Some means or apparatuses according to the present invention refer to some means or apparatuses among these plural means or apparatuses, or some functions or operations in one means or apparatus.

Some means or apparatuses according to the present invention refer to some means or apparatuses among these plural means or apparatuses, or some functions or apparatuses in one means or apparatus, or some functions in one means.

The present invention also covers a recording medium which stores the program according to the present invention and which can be read on a computer.

In one example of use, the program according to the present invention may be recorded in a recording medium which can be read on a computer so that the program operates in co-operation with the computer.

In one example of use, the program according to the present invention may be transmitted through a transmission medium and read by a computer so that the program operates in co-operation with the computer.

The recording medium includes a ROM, etc., whereas the transmission medium includes a transmission medium such as the Internet, light, an electric wave, a sound wave, etc.

The computer referred to above in relation to the present invention is not limited to pure hardware such as a CPU but may include firmware, OS and even peripheral equipment.

As described above, the structure according to the present invention may be realized by software or hardware.

### AVAILABILITY IN THE INDUSTRY

The recording and replaying apparatus according to the present invention shortens the start-up time without increasing the memory capacity of the optical disk drive, and as such, is useful as an optical disk recorder, etc.

1. A recording and replaying apparatus, comprising:
a drive controller which houses an optical disk holding identification information, which is connected to an optical disk drive which controls start-up of and recording and replaying on said optical disk, and which controls said optical disk drive; and
a disk information storage buffer which is connected to said drive controller and stores use conditions which correspond to the identification information of an optical disk,
wherein when use conditions which correspond to the identification information of an optical disk to be used are stored in said disk information storage buffer, said drive controller instructs said optical disk drive so that said optical disk drive executes first adjustment processing using said use conditions, and
when said use conditions which correspond to the identification information of said optical disk to be used are not stored in said disk information storage buffer, said drive controller instructs said optical disk drive so that said optical disk drive executes second adjustment processing without using said use conditions.

2. The recording and replaying apparatus according to claim 1, wherein use conditions obtained as a result of said first adjustment processing or said second adjustment processing are stored in said disk information storage buffer from said optical disk drive.

3. The recording and replaying apparatus according to claim 1, wherein said use conditions for said optical disk are information which is used at the time of recording in said optical disk or replaying from said optical disk, said adjustment processing is processing of identifying use conditions for said optical disk to perform optimal recording or replaying on said optical disk.

4. The recording and replaying apparatus according to claim 3, wherein said information which is used at the time of recording or replaying is information regarding at least one of the power of laser, the pulse width of said laser and a servo condition.

5. The recording and replaying apparatus according to claim 2, wherein the identification information of said optical disk includes at least one of an individual ID, a manufacturer name and a model number, and said first adjustment processing includes first partial adjustment processing and second partial adjustment processing,
when said ID of said optical disk is stored in said disk information storage buffer, said drive controller instructs said optical disk drive so that said optical disk drive executes said first partial adjustment processing using said use conditions for said optical disk which correspond to said ID,
when said ID of said optical disk is not stored in said disk information storage buffer and said manufacturer name and/or said model number of said optical disk is stored in said disk information storage buffer, said drive controller instructs said optical disk drive so that said optical disk drive executes said second partial adjustment processing using said use conditions for said optical disk which correspond to said manufacturer name and/or said model number, and
use conditions obtained as a result of said first partial adjustment processing or said second partial adjustment processing are stored in said disk information storage buffer from said optical disk drive.

6. The recording and replaying apparatus according to claim 3, wherein said drive controller is capable of accessing, through a telecommunication line, a disk information storage device which stores the identification information of said optical disk and use conditions which correspond to the identification information, and
when use conditions which correspond to the identification information of said optical disk to be used are not stored in said disk information storage buffer, said drive controller instructs said optical disk drive so that said optical disk drive acquires use conditions which correspond to the identification information from said disk information storage device through said telecommunication line and executes said first adjustment processing using said use conditions instead of executing said second adjustment processing.

7. The recording and replaying apparatus according to claim 6, wherein said disk information storage device stores said use conditions for each optical disk type and/or each optical disk manufacturer, corresponding to at least one of a manufacturer name, a model type and software information related to said recording and replaying apparatus and hardware information and software information related to said optical disk drive.

8. The recording and replaying apparatus according to claim 7, wherein said information stored in said disk information storage device can be updated through said telecommunication line.

9. The recording and replaying apparatus according to claim 3, wherein said first adjustment processing or said second adjustment processing includes optimization of processing of recording or replaying in accordance with the temperature of said optical disk to be used or an ambient temperature.

10. A recording and replaying method, comprising the steps of:
when use conditions which correspond to identification information of an optical disk to be used in an optical disk drive are stored in a disk information storage buffer of an optical disk recorder which is connected to said optical disk drive, instructing to execute first adjustment processing using said use conditions; and
when said use conditions which correspond to the identification information of said optical disk to be used are not stored in said disk information storage buffer, instructing to execute second adjustment processing without using said use conditions.

11. The recording and replaying method according to claim 10, comprising the step of storing use conditions obtained as a result of said first adjustment processing or said second adjustment processing in said disk information storage buffer.

12. A program which makes a computer function as said drive controller of the recording and replaying apparatus according to claim 1.

13. A recording medium which holds the program according to claim 12 and which can be processed by a computer.

14. A recording and replaying system, comprising:
an optical disk drive which houses an optical disk holding identification information and controls start-up of and recording and replaying on said optical disk;
a drive controller which controls said optical disk drive; and
a disk information storage buffer which is connected to said drive controller and stores use conditions which correspond to the identification information of an optical disk,
wherein when use conditions which correspond to the identification information of an optical disk to be used are stored in said disk information storage buffer, said drive controller instructs said optical disk drive so that said optical disk drive executes first adjustment processing using said use conditions, and
when said use conditions which correspond to the identification information of said optical disk to be used are not stored in said disk information storage buffer, said drive controller instructs said optical disk drive so that said optical disk drive executes second adjustment processing without using said use conditions.

15. The recording and replaying system according to claim 14, wherein use conditions obtained as a result of said first adjustment processing or said second adjustment processing are stored in said disk information storage buffer from said optical disk drive.

16. The recording and replaying system according to claim 14, further comprising a disk information storage device which can be accessed through a telecommunication line and which stores the identification information of an optical disk and use conditions which correspond to the identification information.
